(19) United States
(12) Patent Application Publication
(10) Pub. No.: US 2014/0129235 A1
(43) Pub. Date: May 8, 2014

(54) AUDIO TRACKER APPARATUS

(71) Applicant: Mikko Veli Aimo Suvanto, Pittsburg, PA (US)

(72) Inventor: Mikko Veli Aimo Suvanto, Pittsburg, PA (US)

(73) Assignee: Nokia Corporation, Espoo (FI)

(21) Appl. No.: 14/126,192

(22) PCT Filed: Jun. 17, 2011
(86) PCT No.: PCT/EP2011/060146

§ 371 Date: Dec. 13, 2013

(51) Int. Cl. G10L 21/10

(52) U.S. Cl. CPC G10L 21/10
USPC 704/276

(57) ABSTRACT

Apparatus comprising a receiver configured to receive a first audio signal, a signal characteriser configured to determine at least one characteristic associated with the first audio signal, a comparator configured to compare the at least one characteristic against at least one characteristic associated with at least one further audio signal, and a display configured to display the at least one characteristic associated with at least one further audio signal dependent on the first audio signal characteristic.

### FIELD OF THE APPLICATION

The present invention relates to an apparatus and method for improving tracking of an audio signal. In particular, the present invention relates to an apparatus and method for tracking audio such as music and speech on a visual representation of the audio signal.

### BACKGROUND OF THE APPLICATION

Karaoke machines are well known and their functionality has been introduced in many electronic devices including mobile telephones or user equipment. They typically operate by playing an instrumental version of the song or music to be followed at a specified or default pace or tempo and displays a visual representation of the track or music lyrics with a marker indicating the current position of the audio representation in such a way that the user of the system can attempt to follow the song or music. Paper representation of songs or music, in the form of sheet music have been available for many years and electronic forms of sheet music read by appropriate reader applications or programs which display the electronic version of music sheets or sheet music are known to display the notes and lyrics. Some music applications or programs have also the ability to interpret a suitably encoded file format to generate both a written form and output an audio version of audio so that the user can follow the music track while watching the display to assist a user rehearse the song or music, for example to help the user play a guitar version of the song or music.

### SUMMARY OF SOME EMBODIMENTS

Embodiments aim to address the above problem.

There is provided according to a first aspect a method comprising: receiving a first audio signal; determining at least one characteristic associated with the first audio signal; and comparing the at least one characteristic against at least one characteristic associated with at least one further audio signal; displaying the at least one characteristic associated with at least one further audio signal dependent on the first audio signal characteristic.

The method may further comprise transmitting the at least one characteristic associated with at least one further audio signal dependent on the first audio signal characteristic to an apparatus.

The method may further comprise: receiving at least one indicator associated with the at least one characteristic associated with at least one further audio signal dependent on the first audio signal characteristic; and displaying the at least one indicator associated with the at least one characteristic associated with at least one further audio signal dependent on the first audio signal characteristic.

The method may further comprise: receiving at least one further characteristic associated with the at least one characteristic of the first audio signal; and displaying the at least one further characteristic.

Receiving a first audio signal may comprise at least one of: capturing the audio signal on at least one microphone; and receiving the audio signal via a wired or wireless coupling.

Determining at least one characteristic associated with the first audio signal may comprise at least one of: determining the first audio signal music piece title; determining the first audio signal speech title; determining the first audio signal music piece location; determining the first audio signal speech location; determining the first audio signal tempo; determining the first audio signal note; determining the first audio signal chord; determining the first audio signal frequency response; determining one or more frequency and/or amplitude component of the first audio signal; determining the first audio signal bandwidth; determining the first audio signal noise level and/or signal to noise level ratio; determining the first audio signal phase response; determining the first audio signal loudness; determining the first audio signal impulse response; determining one or more onsets of the first audio signal; determining the first audio signal waveform; determining the first audio signal timbre; determining the first audio signal beat; determining the first audio signal envelope function; determining the first audio signal signal power; determining the first audio signal power spectral density; and determining the first audio signal pitch.

Displaying the at least one characteristic associated with at least one further audio signal dependent on the first audio signal characteristic may comprise at least one of: visually displaying the at least one characteristic associated with at least one further audio signal dependent on the first audio signal characteristic; and audio displaying the at least one characteristic associated with at least one further audio signal dependent on the first audio signal characteristic.

Determining at least one characteristic associated with the first audio signal may comprise determining at least one searchable parameter associated with the first audio signal; and comparing the at least one characteristic against at least one further characteristic associated with at least one further audio signal comprises searching an at least one searchable parameter associated with the at least one further audio signal to determine an at least one further audio signal location.

Comparing the at least one characteristic against at least one further characteristic associated with at least one further audio signal may further comprise determining at least one difference value between an at least one further audio signal location associated with the first audio signal and an expected further audio signal location.

Displaying the at least one characteristic associated with at least one further audio signal dependent on the first audio signal characteristic may comprise displaying the at least one difference value between the at least one further audio signal location associated with the first audio signal and an expected further audio signal location.

Displaying the at least one characteristic associated with at least one further audio signal dependent on the first audio signal characteristic may comprise displaying the at least one further audio signal location associated with the first audio signal on a visual representation of the at least one further audio signal.

Comparing the at least one characteristic against at least one characteristic associated with at least one further audio signal may comprise matching the at least one searchable parameter against at least one searchable parameter associated with the at least one further audio signal.

According to a second aspect there is provided a method comprising: receiving at least one characteristic of the first audio signal compared against the at least one characteristic associated with at least one further audio signal from at least one slave apparatus; displaying the at least one characteristic associated with at least one further audio signal dependent on the first audio signal characteristic on a master apparatus; determining synchronisation information for each slave apparatus; and transmitting to each slave apparatus synchronisation information.

According to a third aspect there is provided an apparatus comprising at least one processor and at least one memory including computer program code for one or more programs, the at least one memory and the computer program code configured to, with the at least one processor, cause the apparatus at least to perform: receiving a first audio signal; determining at least one characteristic associated with the first audio signal; comparing the at least one characteristic against at least one characteristic associated with at least one further audio signal; and displaying the at least one characteristic associated with at least one further audio signal dependent on the first audio signal characteristic.

The apparatus may be further caused to perform transmitting the at least one characteristic associated with at least one further audio signal dependent on the first audio signal characteristic to a further apparatus.

The apparatus may be further caused to perform: receiving at least one indicator associated with the at least one characteristic associated with at least one further audio signal dependent on the first audio signal characteristic; and displaying the at least one indicator associated with the at least one characteristic associated with at least one further audio signal dependent on the first audio signal characteristic.

The apparatus may be further caused to perform: receiving at least one further characteristic associated with the at least one characteristic of the first audio signal; and displaying the at least one further characteristic.

Receiving a first audio signal may further cause the apparatus to perform at least one of: capturing the audio signal on at least one microphone; and receiving the audio signal via a wired or wireless coupling.

Determining at least one characteristic associated with the first audio signal may further cause the apparatus to perform at least one of: determining the first audio signal music piece title; determining the first audio signal speech title; determining the first audio signal music piece location; determining the first audio signal speech location; determining the first audio signal tempo; determining the first audio signal note; determining the first audio signal chord; determining the first audio signal frequency response; determining one or more frequency and/or amplitude component of the first audio signal; determining the first audio signal bandwidth; determining the first audio signal noise level and/or signal to noise level ratio; determining the first audio signal phase response; determining the first audio signal loudness; determining the first audio signal impulse response; determining one or more onsets of the first audio signal; determining the first audio signal waveform; determining the first audio signal timbre; determining the first audio signal envelope function; determining the first audio signal signal power; determining the first audio signal power spectral density; determining the first audio signal beat; and determining the first audio signal pitch.

Displaying the at least one characteristic associated with at least one further audio signal dependent on the first audio signal characteristic may further cause the apparatus to perform at least one of: visually displaying the at least one characteristic associated with at least one further audio signal dependent on the first audio signal characteristic; and audio displaying the at least one characteristic associated with at least one further audio signal dependent on the first audio signal characteristic.

Determining at least one characteristic associated with the first audio signal may further causes the apparatus to perform determining at least one searchable parameter associated with the first audio signal; and comparing the at least one characteristic against at least one further characteristic associated with at least one further audio signal further causes the apparatus to perform searching an at least one searchable parameter associated with the at least one further audio signal to determine an at least one further audio signal location.

Comparing the at least one characteristic against at least one further characteristic associated with at least one further audio signal may further cause the apparatus to perform determining at least one difference value between an at least one further audio signal location associated with the first audio signal and an expected further audio signal location.

Displaying the at least one characteristic associated with at least one further audio signal dependent on the first audio signal characteristic may further cause the apparatus to perform displaying the at least one difference value between the at least one further audio signal location associated with the first audio signal and an expected further audio signal location.

Displaying the at least one characteristic associated with at least one further audio signal dependent on the first audio signal characteristic may further cause the apparatus to perform displaying the at least one further audio signal location associated with the first audio signal on a visual representation of the at least one further audio signal.

Comparing the at least one characteristic against at least one further characteristic associated with at least one further audio signal may further cause the apparatus to perform matching the at least one searchable parameter against at least one searchable parameter associated with the at least one further audio signal.

According to a fourth aspect there is provided an apparatus comprising at least one processor and at least one memory including computer program code for one or more programs, the at least one memory and the computer program code configured to, with the at least one processor, cause the apparatus at least to perform: receiving at least one the at least one characteristic associated with at least one further audio signal dependent on the first audio signal characteristic from at least one slave apparatus; displaying the at least one characteristic associated with at least one further audio signal dependent on the first audio signal characteristic; determining synchronisation information for each slave apparatus; and transmitting to each slave apparatus synchronisation information.

According to a fifth aspect there is provided an apparatus comprising: means for receiving a first audio signal; means for determining at least one characteristic associated with the first audio signal; means for comparing the at least one characteristic against at least one characteristic associated with at least one further audio signal; and means for displaying the at least one characteristic associated with at least one further audio signal dependent on the first audio signal characteristic.

The apparatus may further comprise means for transmitting the at least one characteristic associated with at least one further audio signal dependent on the first audio signal characteristic to a further apparatus.

The apparatus may further comprise: means for receiving at least one indicator associated with the at least one characteristic associated with at least one further audio signal dependent on the first audio signal characteristic; and means for displaying the at least one indicator associated with the at least one characteristic associated with at least one further audio signal dependent on the first audio signal characteristic.

The apparatus may further comprise: means for receiving at least one further characteristic associated with the at least one characteristic of the first audio signal; and means for displaying the at least one further characteristic.

Means for receiving a first audio signal may comprise at least one of: means for capturing the audio signal on at least one microphone; and means for receiving the audio signal via a wired or wireless coupling.

Means for determining at least one characteristic associated with the first audio signal may comprise at least one of: means for determining the first audio signal music piece title; means for determining the first audio signal speech title; means for determining the first audio signal music piece location; means for determining the first audio signal speech location; means for determining the first audio signal tempo; means for determining the first audio signal note; means for determining the first audio signal chord; means for determining the first audio signal frequency response; means for determining one or more frequency and/or amplitude component of the first audio signal; means for determining the first audio signal bandwidth; means for determining the first audio signal noise level and/or signal to noise level ratio; means for determining the first audio signal phase response; means for determining the first audio signal loudness; means for determining the first audio signal impulse response; means for determining one or more onsets of the first audio signal; means for determining the first audio signal waveform; means for determining the first audio signal timbre; means for determining the first audio signal beat; means for determining the first audio signal envelope function; means for determining the first audio signal signal power; means for determining the first audio signal power spectral density; and means for determining the first audio signal pitch.

Means for displaying the at least one characteristic associated with at least one further audio signal dependent on the first audio signal characteristic may comprise at least one of: means for visually displaying the at least one characteristic associated with at least one further audio signal dependent on the first audio signal characteristic; and means for audio displaying the at least one characteristic associated with at least one further audio signal dependent on the first audio signal characteristic.

Means for determining at least one characteristic associated with the first audio signal may comprise means for determining at least one searchable parameter associated with the first audio signal; and means for comparing the at least one characteristic against at least one further characteristic associated with at least one further audio signal comprises means for searching an at least one searchable parameter associated with the at least one further audio signal to determine an at least one further audio signal location.

Means for comparing the at least one characteristic against at least one further characteristic associated with at least one further audio signal may further comprise means for determining at least one difference value between an at least one further audio signal location associated with the first audio signal and an expected further audio signal location.

Means for displaying the at least one characteristic associated with at least one further audio signal dependent on the first audio signal characteristic may comprise means for displaying the at least one difference value between the at least one further audio signal location associated with the first audio signal and an expected further audio signal location.

Means for displaying the at least one characteristic associated with at least one further audio signal dependent on the first audio signal characteristic may comprise means for displaying the at least one further audio signal location associated with the first audio signal on a visual representation of the at least one further audio signal.

Means for comparing the at least one characteristic against at least one further characteristic associated with at least one further audio signal may comprise means for matching the at least one searchable parameter against at least one searchable parameter associated with the at least one further audio signal.

According to a sixth aspect there is provided an apparatus comprising: means for receiving at least one characteristic associated with at least one further audio signal dependent on the first audio signal characteristic from at least one slave apparatus; means for displaying the at least one characteristic associated with at least one further audio signal dependent on the first audio signal characteristic; means for determining synchronisation information for each slave apparatus; and means for transmitting to each slave apparatus synchronisation information.

According to a seventh aspect there is provided an apparatus comprising: a receiver configured to receive a first audio signal; a signal characteriser configured to determine at least one characteristic associated with the first audio signal; a comparator configured to compare the at least one characteristic against at least one characteristic associated with at least one further audio signal; and a display configured to display the at least one characteristic associated with at least one further audio signal dependent on the first audio signal characteristic.

The apparatus may further comprise a transmitter configured to transmit the at least one characteristic associated with at least one further audio signal dependent on the first audio signal characteristic to a further apparatus.

The apparatus may further comprise: the receiver further configured to receive at least one indicator associated with the at least one characteristic associated with at least one further audio signal dependent on the first audio signal characteristic; and the display further configured to display the at least one indicator associated with the at least one characteristic associated with at least one further audio signal dependent on the first audio signal characteristic.

The apparatus may further comprise: the receiver further configured to receive at least one further characteristic associated with the at least one characteristic of the first audio signal; and the display further configured to display the at least one further characteristic.

The receiver may comprise at least one microphone configured to capture the audio signal.

The signal characteriser may comprise at least one of: a title determiner configured to determine the first audio signal music piece title or the first audio signal speech title; a locator configured to determine the first audio signal music piece location or the first audio signal speech location; a tempo determiner configured to determine the first audio signal tempo; a note determiner configured to determine the first audio signal note; a chord determiner configured to determine the first audio signal chord; a frequency response determiner configured to determine the first audio signal frequency response; an amplitude determiner configured to determine one or more frequency and/or amplitude component of the first audio signal; a bandwidth determiner configured to determine the first audio signal bandwidth; a noise determiner configured to determine the first audio signal noise level and/or signal to noise level ratio; a phase response determiner configured to determine the first audio signal phase response; a loudness determiner configured to determine the first audio signal loudness; an impulse response determiner configured to determine the first audio signal impulse response; an onset determiner configured to determine one or more onsets of the first audio signal; a waveform determiner configured to determine the first audio signal waveform; a timbre determiner configured to determine the first audio signal timbre; a beat determiner configured to determine the first audio signal beat; and a pitch determiner configured to determine the first audio signal pitch.

The display may comprise at least one of: a visual display; and an audio display.

The signal characteriser may comprise a parameter determiner configured to determine at least one searchable parameter associated with the first audio signal; and the comparator comprises a searcher configured to search an at least one searchable parameter associated with the at least one further audio signal to determine an at least one further audio signal location.

The comparator may comprise a difference determiner configured to determine at least one difference value between an at least one further audio signal location associated with the first audio signal and an expected further audio signal location.

The display may be further configured to display the at least one difference value between the at least one further audio signal location associated with the first audio signal and an expected further audio signal location.

The display may be further configured to display the at least one further audio signal location associated with the first audio signal on a visual representation of the at least one further audio signal.

The comparator may comprise a matcher configured to match the at least one searchable parameter against at least one searchable parameter associated with the at least one further audio signal.

According to an eighth aspect there is provided an apparatus comprising: a receiver configured to receive the at least one characteristic associated with at least one further audio signal dependent on the first audio signal characteristic from at least one slave apparatus; a display configured to display the at least one characteristic associated with at least one further audio signal dependent on the first audio signal characteristic; a difference determiner configured to determine synchronisation information for each slave apparatus; and a transmitter configured to transmit to each slave apparatus the synchronisation information.

A computer program product stored on a digital medium may cause an apparatus to perform the method as described herein.

An electronic device may comprise apparatus as described herein. A chipset may comprise apparatus as described herein.

### BRIEF DESCRIPTION OF DRAWINGS

For better understanding of the present invention, reference will now be made by way of example to the accompanying drawings in which:

FIG. 1 shows schematically an electronic device employing embodiments of the application;

FIG. 2 shows schematically an audio tracker according to some embodiments of the application;

FIG. 3 shows schematically a digital signal processor as shown in FIG. 2 in further detail according to some embodiments of the application;

FIG. 4 shows schematically a signal comparator as shown in FIG. 2 in further detail according to some embodiments of the application;

FIG. 5 shows a flow diagram detailing the operation of the audio tracker shown in FIG. 2 according to some embodiments of the application;

FIG. 6 shows possible user interactions affecting the operation of the audio tracker according to some embodiments of the application;

FIG. 7 shows an example of the operation of some embodiments of the application;

FIG. 8 shows a flow diagram detailing the operation of the digital signal processor shown in FIG. 3 according to some embodiments of the application;

FIG. 9 shows a flow diagram detailing the operation of the signal comparator shown in FIG. 4 according to some embodiments of the application;

FIG. 10 shows networking of master and slave audio trackers according to some embodiments of the application; and

FIG. 11 shows a flow diagram detailing the operation of the master and slave audio trackers according to some embodiments of the application.

### DESCRIPTION OF SOME EMBODIMENTS OF THE APPLICATION

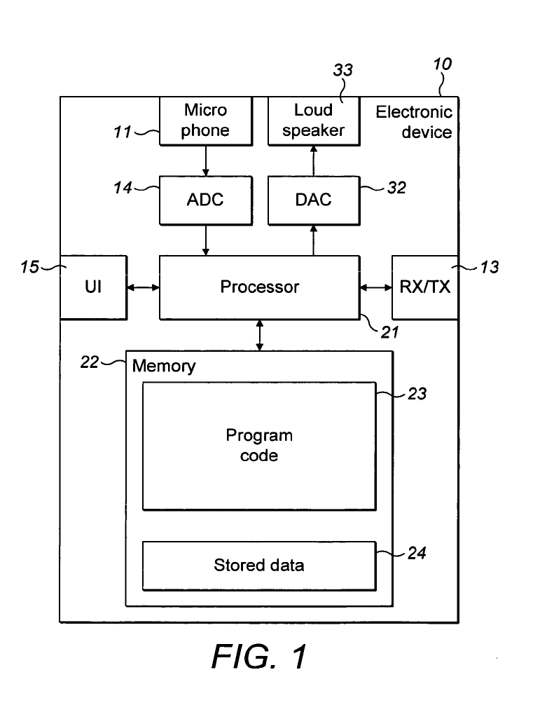

The following describes in more detail possible mechanisms for the provision of tracking a received or captured audio signal in such a way that a position within a song or composition or speech can be determined and displayed to the user in a suitable form. In this regard reference is first made to FIG. 1 which shows a schematic block diagram of an exemplary electronic device 10 or apparatus, which may incorporate an audio tracker system according to some embodiments.

The apparatus 10 can for example be as described herein a mobile terminal or user equipment of a wireless communication system. In some other embodiments the apparatus 10 can be any suitable audio or audio-subsystem component within an apparatus such as audio player (also known as MP3 players) or media players (also known as MP4 players). In some other embodiments, the apparatus can be any portable electronic apparatus with video output, for example a personal computer, laptop, netbook, net top computer, and tablet computer.

The apparatus 10 can comprise in some embodiments a microphone 11, which is linked via an analogue-to-digital converter (ADC) 14 to a processor 21. The processor 21 is further linked in some embodiments via a digital-to-analogue converter (DAC) 32 to loudspeaker(s) 33. The processor 21 is in some embodiments further linked to a transceiver (RX/TX) 13, to a user interface (UI) 15 and to a memory 22.

The processor 21 can be in some embodiments configured to execute various program codes or applications also known as apps. The implemented program codes 23 can comprise an audio matching code, audio following or tracking code, or audio ‘display’ code. The implemented program codes 23 can in some embodiments be stored for example in the memory 22 for retrieval by the processor 21 whenever needed. The memory 22 could further provide a section 24 for storing data, for example data that has been encoded in accordance with the application.

The code can in some embodiments be implemented in electronic based hardware or firmware.

In some embodiments the apparatus can comprise a user interface 15. The user interface 15 enables a user to input commands to the apparatus 10, for example via a keypad, keyboard, voice user interfacing, a touchscreen display input and/or to obtain information from the apparatus 10, for example via a display or display interface.

Furthermore in some embodiments the apparatus 10 further comprises a transceiver 13. The transceiver 13 enables a communication with other electronic devices, for example via a wireless communication network.

It is to be understood that the structure of the apparatus 10 could be supplemented and varied in many ways.

The apparatus 10 can in some embodiments receive a bit stream with suitably encoded data, for example a bit stream comprising recorded or captured audio signals from another apparatus or electronic device via its transceiver 13. Alternatively, coded data could be stored in the data section 24 of the memory 22, for instance for a later presentation by the same apparatus 10. In both cases, the processor 21 may execute the program code stored in the memory 22.

The processor 21 can therefore in some embodiments decode the received data, process the data according to embodiments described herein and provide the data to the digital-to-analogue converter 32. The digital-to-analogue converter 32 can then in some embodiments convert the digital decoded data into analogue audio data and output the audio signal via the loudspeaker(s) 33. However it would be understood that the loudspeaker or loudspeakers 33 can in some embodiments be any suitable audio transducer converting electrical signals into presentable acoustic signals.

Execution of the program codes could in some embodiments be triggered by an application that has been called by the user via the user interface 15.

The received encoded data could also be stored instead of an immediate processing in the data section 24 of the memory 22, for instance for enabling a later presentation, tracking or a forwarding to still further electronic device.

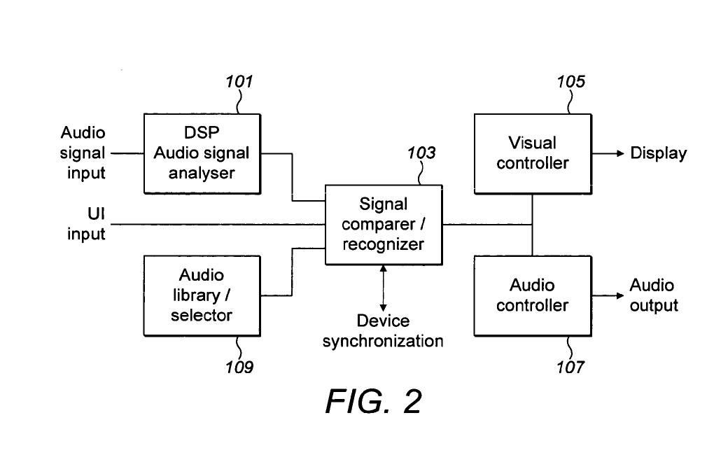

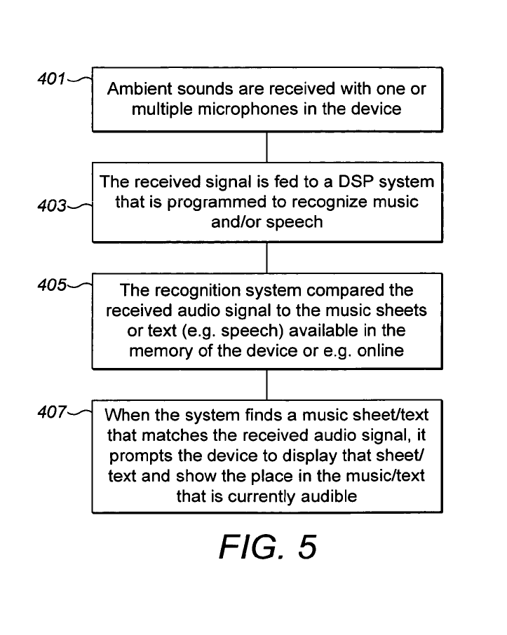

It would be appreciated that the schematic structures described in FIGS. 2 to 4 and 10 and the method steps in FIGS. 5, 6, 8, 9, and 11 represent only a part of the operation of an audio tracker as exemplarily shown implemented in the electronic device shown in FIG. 1.

Embodiments of the application are now described in more detail with respect to FIGS. 2 to 11.

In some embodiments of this application as described herein, an enriched music following or tracking experience is presented wherein the visual music representation, also known as digital sheet music and/or digital music sheets are interactive and aware of the surroundings. For example the apparatus in some embodiments is ‘aware’ of the music that the musicians are playing, the speaker is speaking, or the vocalist is singing. The music tracking, for example, can be used as part of an ‘improved’ karaoke system enabling the karaoke system to follow the tempo of the singer rather than force the singer to match the tempo of the karaoke track. Similarly a person practising a piece of music or speech can play the speech or song or track at the pace which they are comfortable to learn at. For example a person attempting to learn a guitar song can play the song or track at a slower pace than the normal tempo in order that the person can follow the correct chord or plucking progression accurately rather than forcing the person to attempt to keep up with the song tempo or requiring the person to pause and replay a section over and over again. A musician using such embodiments as described herein could also reduce the number of repetitions of the music piece as the piece is being rehearsed and remove the need to flip the sheet back and forth in rehearsals.

Embodiments of the application thus enable a visual representation of the music to be displayed by the apparatus which is able to interact with the environment and follow the musicians and the music that is being played. Thus for example the apparatus can be configured by using microphones to receive the audible sound signals in the room as music is being played with musical instruments. Then digital signal processing (DSP) within the apparatus can process the received music or speech and comparators can furthermore compare the processed signals to music or audio information, stored or made available to the apparatus to determine the music track, song or speech and where in the track, song or speech the apparatus received or captured audio signal is. Furthermore after determining the position of the audio track, also known as point on the sheet music, the apparatus can output via a display the position in the music track or song on the visual representation, digital sheet music, where the apparatus believes the user to be located. This positioning information can be displayed, for example by a dot bouncing on top of the notes or by “painting” the part that has already has been played.

Thus in embodiments of the application the apparatus as described herein reduces the need to turn ‘pages’ in conventional sheet music. Furthermore apparatus incorporating embodiments of the application can also remove the risk of a musician losing their place on the music sheet.

As furthermore described in some embodiments by using synchronization between multiple apparatus, for example each apparatus associated and/or monitoring a separate instrument, the apparatus can show the same point on the visual display of the music piece being performed by all of them. In other words, making sure that the band or orchestra are all on the “same page”.

It will also be understood that in some embodiments that voice/word recognition can be applied to track speech in a similar manner to those methods described herein.

In some embodiments the apparatus can monitor an externally received song to determine the song and the part of the song being performed to assist the listener of the song as well as the performer. In some such embodiments of the application, as described herein, the music or song received can itself be “recognised” by the apparatus enabling the apparatus to automatically display the music sheet and/or lyrics of the music being performed where the listener is not familiar or cannot remember the song or track.

In some embodiments, the apparatus as described herein could be configured to aid the music performer about any mistakes that have been made, for example determining when the rhythm is not stable, or an incorrect note of chord having been played and thus indicate to the user a correction or corrective action to be performed such as speeding up or slowing down of the pace of the performance of the instrument.

This, for example, could be used as part of an “intelligent karaoke” system which follows the user or performer enabling the apparatus to change the pace of the song to match the user without changing the pitch, and also able to tell the performer to speed up/down, change pitch or some other change to the singing style.

Similarly an “intelligent personal teleprompter” like those used by public performers could be implemented in some embodiments using the apparatus to compare the words written in a speech to the words being spoken by the user or performer, as the apparatus can display the correct or right point in the speech without the user having to worry about losing their place and allow the speaker to monitor their pace as they present their speech.

With respect to FIG. 2, the audio tracker is shown according to some embodiments. The audio tracker in some embodiments comprises a DSP audio signal analyser 101. The DSP audio signal analyser 101 or means for receiving a first audio signal can be configured to receive an audio signal input. The audio signal input can in some embodiments be the input from at least one microphone, an array of microphones, an audio input such as audio analogue jack input, a digital audio input, an audio signal received via the transceiver or any other suitable audio signal input. Thus in some embodiments the apparatus comprises means for capturing the audio signal on at least one microphone and/or means for receiving the audio signal via a wired or wireless coupling.

In some embodiments the audio signal input is at least one analogue audio signal input. In such embodiments the analogue audio signal input can be pre-processed into a digital format for further processing. Furthermore in some embodiments the audio signal input is received from more than one source and as such can be pre-processed in order to identify a primary or significant audio source from the ambient noise. In some embodiments the ambient noise can be separated from the primary signal and be output to further apparatus or devices to assist in synchronising the apparatus as described herein. In some embodiments the microphone or microphones configured to capture or receive the audio signals are integral to the apparatus.

The operation of receiving the audio signal input is shown in FIG. 5 by step 401.

Furthermore the digital signal processor audio signal analyser 101, signal characteriser or means for determining at least one characteristic associated with the first audio signal, can be configured to perform an analysis on the audio signal to produce or generate some searchable characteristics from the received audio signal or signals. The searchable audio characteristics can be passed to the signal comparer/recogniser 103. In some embodiments the DSP audio signal analyser 101 can furthermore be configured to perform a speech/music determination on the input audio signal in order to determine whether or not the input audio signal is primarily speech or primarily a music track and this generate searchable characteristics or parameters which match whether the audio is music or speech. The means for determining can comprise at least one of the following in some embodiments, means for determining the first audio signal music piece title, means for determining the first audio signal speech title, means for determining the first audio signal music piece location, means for determining the first audio signal speech location, means for determining the first audio signal tempo, means for determining the first audio signal note, means for determining the first audio signal chord, means for determining the first audio signal frequency response, means for determining one or more frequency and/or amplitude component of the first audio signal; means for determining the first audio signal bandwidth, means for determining the first audio signal noise level and/or signal to noise level ratio, means for determining the first audio signal phase response, means for determining the first audio signal loudness, means for determining the first audio signal impulse response, means for determining one or more onsets of the first audio signal, means for determining the first audio signal waveform, means for determining the first audio signal timbre, means for determining the first audio signal beat, means for determining the first audio signal envelope function; means for determining the first audio signal signal power; means for determining the first audio signal power spectral density; and means for determining the first audio signal pitch.

The operation of generating and/or producing parameters and/or characteristics recognising music and/or speech is shown in FIG. 5 by step 403.

In some embodiments the audio tracker comprises a signal comparer/recogniser or comparator 103. The signal comparer/recogniser 103 can be configured to receive the output of the DSP audio signal analyser 101 and in some embodiments at least one searchable characteristic associated with the input audio signal. The signal comparer/recogniser 103 can in some further embodiments receive a user interface input, for example from a touch screen display, keyboard or keypad as described herein. Furthermore the signal comparer/recogniser 103 can in some embodiments receive an input from the audio library/selector 109. The signal comparer/recogniser 103 can in some embodiments further receive a device synchronisation input or output device synchronisation data to other apparatus.

The signal comparer/recogniser 103 can be configured to receive the searchable parameter or characteristic information from the DSP audio signal analyser 101 and compare the at least one searchable parameter or characteristic against a known track or speech characteristic to enable a track position determination to be found. In other words the apparatus can in some embodiments comprise means for comparing the at least one characteristic against at least one further characteristic associated with at least one further audio signal. The track position estimate can then be output, for example, to the official controller 105, the audio controller 107, and in some embodiments via the device synchronisation output. Thus for example the means for determining can comprise means for determining at least one searchable parameter associated with the first audio signal; and means for comparing the at least one characteristic against at least one further characteristic associated with at least one further audio signal comprises means for searching an at least one searchable parameter associated with the at least one further audio signal to determine an at least one further audio signal location. Furthermore the means for comparing may comprise in some embodiments means for determining at least one difference value between an at least one further audio signal location associated with the first audio signal and an expected further audio signal location. Such means for comparing the at least one characteristic against at least one further characteristic associated with at least one further audio signal may furthermore in some embodiments comprise means for matching the at least one searchable parameter against at least one searchable parameter associated with the at least one further audio signal.

The operation of comparing the received audio signal to the music library or sheet music or text available in the memory of the device or available on an external music database is shown in FIG. 5 by step 405.

In some embodiments the apparatus comprises a visual controller 105 configured to receive the estimated track or speech location estimate and output to the display an associated position on, for example, a sheet of music representation of the track. In other words the apparatus can comprise in some embodiments means for displaying the at least one characteristic associated with at least one further audio signal dependent on the first audio signal characteristic.

The operation of displaying the sheet/text and showing the place on the music sheet or text that is currently audible is shown in FIG. 5 by step 407. For example in some embodiments the means for displaying the at least one characteristic associated with at least one further audio signal dependent on the first audio signal characteristic may comprise means for displaying the at least one difference value between the at least one further audio signal location associated with the first audio signal and an expected further audio signal location. Furthermore in some embodiments the means for displaying the at least one characteristic associated with at least one further audio signal dependent on the first audio signal characteristic may comprise means for displaying the at least one further audio signal location associated with the first audio signal on a visual representation of the at least one further audio signal.

Furthermore in some embodiments the apparatus comprises an audio controller 107. The audio controller 107 can thus in some embodiments mix the incoming audio signal with any audio library signal to be output or in some embodiments to attempt to match the audio signal output to the audio signal input. In some embodiments the audio controller 107 can output a digital audio output to be passed to the digital-to-analogue converter 22 prior to be passed to the loudspeaker 33.

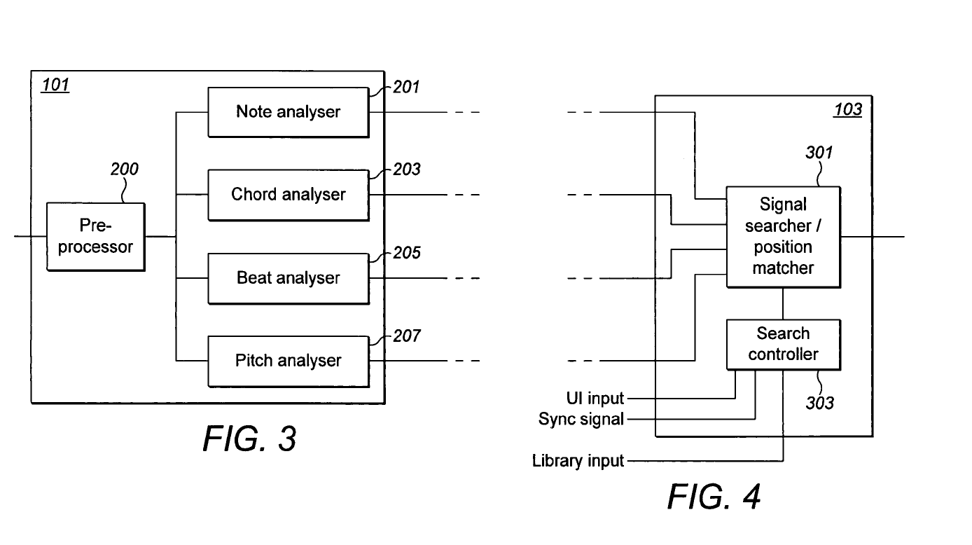

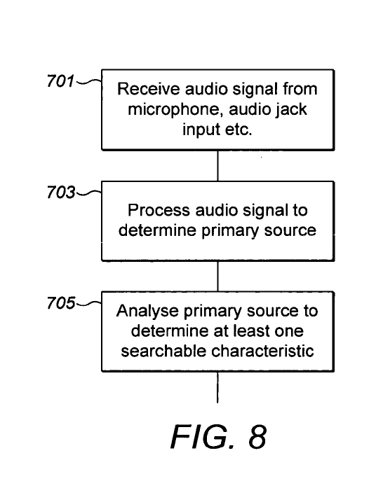

With respect to FIG. 3 the digital signal processor audio signal analyser 101 is shown in further detail. Furthermore the operation of the digital signal processor is described with respect to FIG. 8.

In some embodiments the digital signal processor audio signal analyser 101 comprises a pre-processor 200. The pre-processor 200 can be configured to receive the at least one audio signal input and pre-processes the audio signal input in such a way that it can be processed by the subsequent analyser components.

For example in some embodiments the audio signal input is an analogue signal and as such the pre-processor 200 can be configured to perform an analogue to digital conversion on the audio signal input to output a suitable digital signal output. Furthermore in some embodiments the pre-processor 200 can be configured to receive multiple audio signal inputs from multiple distributed microphones. For example as described here the microphones can in some embodiments be mounted on the apparatus casing or the audio signal can be received from microphones or further apparatus transmitting the audio signals which are received at the apparatus via a wireless communications link. In such embodiments the pre-processor can be configured to perform a directional analysis of the received audio signals in order to determine a primary audio source. For example in some embodiments a spatial filtering operation can be performed by the pre-processor 200 to filter out any ambient audio signals from the desired audio signal generated by the primary audio source to reduce any errors in the later analysis operations.

In some embodiments the pre-processor 200 can be configured to receive a user interface input and perform filtering dependent on the user interface input. For example in some embodiments the user could select a microphone or a direction from an array of microphones such that the audio tracking operation is carried out based on the user's audio input selection. In some embodiments the pre-processor 200 comprises a time to frequency domain transformer configured to output a frequency domain representation of the input audio signal to assist in the analysis of the audio signal. In some embodiments the time to frequency domain transformation can comprise any suitable transform such as for example but not exclusively a fast fourier transform (FFT), discrete fourier transform (DFT), and modified cosine transform (MCT).

The output of the pre-processor 200 can in some embodiments be passed to the at least one analyser component.

The operation of receiving the audio signal, for example, from the microphone, audio jack input or any other suitable input can be seen in FIG. 8 by step 701.

Furthermore the operation to process the audio signal to determine the primary source can be seen in FIG. 8 by the step 703.

In some embodiments the DSP audio signal analyser 101 can comprise at least one analyser component. In the example shown in FIG. 3 the DSP audio signal analyser 101 comprises four separate analyser component stages. These four analysers shown in FIG. 3 are; a note analyser 201, a chord analyser 203, a beat analyser 205, and a pitch analyser 207. It would be understood that further or fewer analyser components can be implemented. Furthermore any suitable analysis result can be performed. For example a music/speech determiner analyser could be implemented in some embodiments of the application. In some embodiments an analyser can furthermore be used as an input to a further analyser, for example the pitch analyser 207 could in some embodiments be used to assist the analysis of the audio signal in the chord analyser.

In some embodiments the audio signal analyser 101 comprises a note analyser 201. The note analyser can be configured to determine the note of the audio signal input. The note analyser can for example perform any suitable note analysis on the audio signal. The output of the note analyser 201 can be passed to the signal comparer or comparator/recogniser 103.

In some embodiments the audio signal analyser 101 can comprise a chord analyser 203. The chord analyser can be configured to determine whether or not the audio signal input is a single note or a chord combination of multiple notes, and furthermore in some embodiments determine the relationship between the notes to estimate the notes. For example in some embodiments the fourier representation of the audio signal is analysed to determine appropriate frequency peaks. The output of the chord analyser 203 can be passed also to the signal comparer/recogniser 103. The chord analyser 203 can be any suitable chord analysis operation.

In some embodiments the DSP audio signal analyser 101 comprises a beat analyser 205. The beat analyser 205 can, for example, be configured to determine the beat or the tempo of the input audio signal. The beat analyser can perform the operation by any suitable beat or tempo analysis operation. The output of the beat analyser 205 can be passed to the signal searcher or signal comparator 103.

In some embodiments the DSP audio signal analyser 101 can further comprise a pitch or fundamental frequency analyser 207. The pitch analyser 207 can be configured to determine the fundamental frequency of the audio signal input. The pitch analyser 207 can perform any suitable pitch analysis.

The operation to analysis the primary source to determine at least one searchable characteristic can be seen in FIG. 8 by step 705.

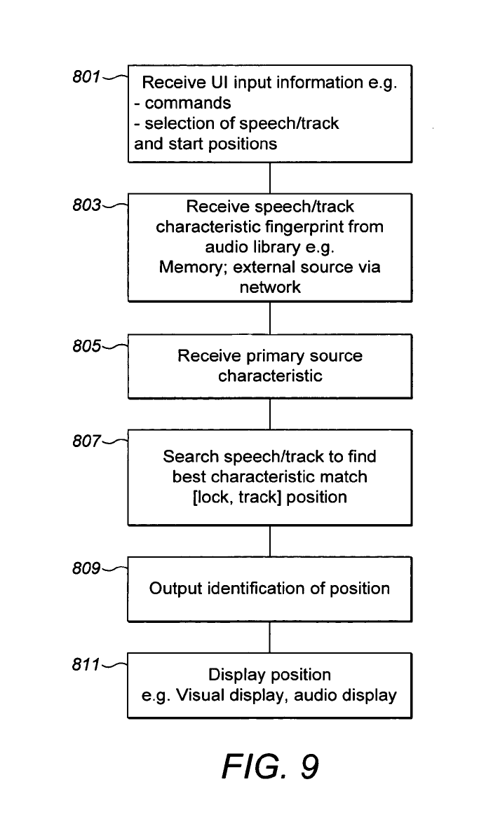

With respect to FIG. 4, the search signal comparator/recogniser 103 is shown in further detail. Furthermore with respect to FIG. 9 the operation of the signal comparator/recogniser 103 according to some embodiments of the application is shown in further detail.

In some embodiments the signal comparator 103 can comprise a search controller 303. The search controller 303 can in some embodiments receive at least one input configured to determine the control of the signal comparison operation. For example in the example shown in FIG. 4 the search controller is configured to receive a user interface input. The user interface input can for example be a command selecting the speech or track to be followed by the audio signal input. In some other embodiments the user interface input to the search controller 303 can also provide a start, or guestimated position from which the search is to be performed or to indicate where the performer is to start playing or speaking. It would be understood that any other suitable input could be provided from the user interface input.

Furthermore in some embodiments the search controller 303 can be configured to receive a synchronisation signal or output a suitable synchronisation signal from the controller 303. The operation of the synchronisation signal is described herein however it would be understood that, for example, a synchronisation signal passed to the search controller could indicate to the search controller 303 that the apparatus is a “slave device” and furthermore in some embodiments indicate to the apparatus or signal comparator 103 that the master device is at a particular location on the music sheet/speech to assist the signal searcher to produce an estimate around or about this defined position. In some further embodiments the synchronisation signal could be used to identify via the visual controller where the “master device” is so that the difference between the master device and the current device can be determined and displayed to the performer. In other words in some embodiments the apparatus can comprise means for transmitting the at least one characteristic associated with at least one further audio signal dependent on the first audio signal characteristic to a further apparatus. Furthermore in some embodiments the apparatus can comprise means for receiving at least one indicator associated with the at least one characteristic associated with at least one further audio signal dependent on the first audio signal characteristic; and means for displaying the at least one indicator associated with the at least one characteristic associated with at least one further audio signal dependent on the first audio signal characteristic.

In some embodiments the search controller 303 can further be configured to receive inputs from the library. The library as discussed herein can be internal to the apparatus, for example stored on memory on or associated with the apparatus or received via a communications network or communications link from a further apparatus external to the apparatus. In some embodiments the search controller 303 can receive from the library input speech/track characteristic finger print information from the audio library to be provided to the signal searcher/position matcher 301 based on the user interface input.

The operation of receiving the user interface input information is shown in FIG. 9 by step 801.

The operation of receiving the selected speech/track characteristic finger print from the audio library is shown in FIG. 9 by step 803.

The search controller 303 can thus output the finger print information to the signal searcher/position matcher 301.

The signal comparator 103 in some embodiments comprises a signal searcher/position matcher 301. The signal searcher/position matcher 301 is configured to receive the at least one characteristic generated from the received audio signal and furthermore in some embodiments information from the library, for example a selected speech/track characteristic finger print comprising a series of characteristic values associated with the music track/speech selected by the user interface input. In some embodiments, for example where the signal searcher/position matcher 301 is supplied with a series of music track information finger prints, the signal searcher/position matcher can be configured to identify the track and/or speech as well as the position on the track and/or speech.

The signal searcher/position matcher 301 is thus configured to receive the primary source characteristic information from the DSP audio signal analyser 101.

The operation of receiving the primary source characteristic is shown in FIG. 9 by step 805.

The signal searcher/position matcher 301 can in some embodiments be configured to search the track/speech characteristic finger print information to determine where the input characteristic audio signal information is on the track. In some embodiments this can be performed as an initial lock or locking operation followed by a tracking operation. In other words the whole of the selected music sheet track or speech is searched initially and then after determining a first position, this initial position is used as a starting point from which the further audio signals are searched from. In some embodiments the signal searcher/position matcher can be any suitable matching or determination method. For example the signal searcher/position matcher 301 can implement a minimum error search comparing the audio signal characteristics to the selected music or speech finger print characteristic values. However it would understood that in some other embodiments, any suitable search or matching operation can be performed such as, for example, the use of neural networks, multi-dimensional error analysis, Eigenvalue or Eigenvector analysis, and singular value determinant analysis.

The operation of searching the speech/track to find the best characteristic match position is shown in FIG. 9 by step 807.

The signal searcher/position matcher 301 can thus in embodiments output the identification of the track or speech position to the visual and/or audio controller.

The operation of outputting the identification of the track or speech position is shown in FIG. 9 by step 809.

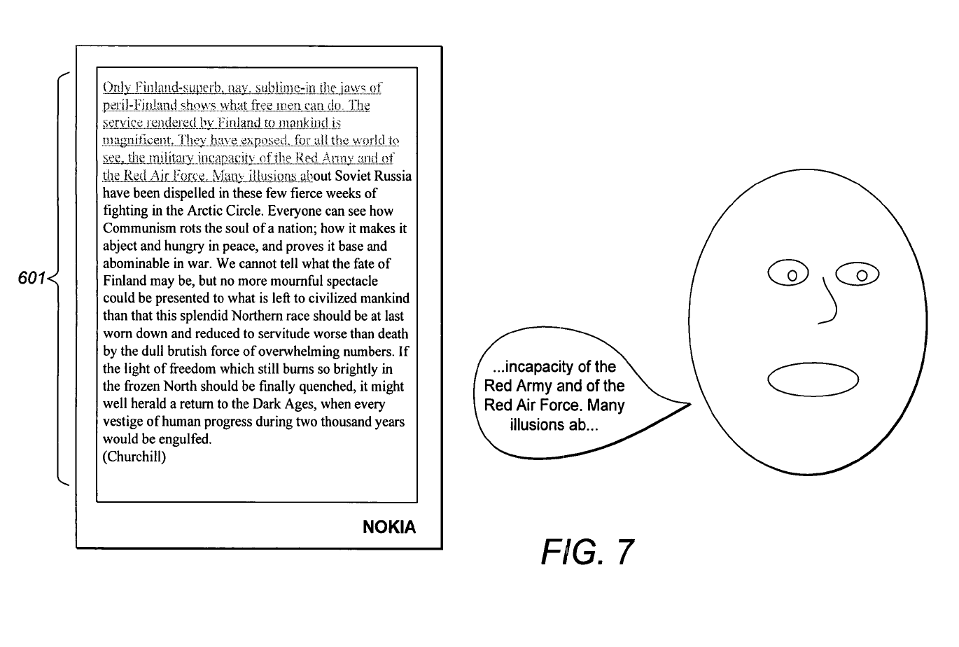

Furthermore the visual controller and/or audio controller 107 can be configured to display the position of the audio signal in relation to the track or speech to be performed. With respect to FIG. 7, an example of the display of the position is shown wherein on the display screen 601 the speech as a whole is displayed with the current position indicated by the end of the underlining. It would be understood however that the display could be by any suitable form such as highlighting, strikethrough, colour change of text, scrolling of text, or other identifier above, below or in-line with the text being spoken. A similar display can be performed with respect to showing the position of the received or captured audio signal with respect to a music representation. For example the notes can be displayed changing colour or scrolling underneath a gate region of the display. In some embodiments the visual controller 105 can be configured to receive from the audio library the digitally presentable form of the music, such as an intractable electronic sheet music form such that the position of the captured audio signal can be located on the sheet music and displayed to the operator or user.

The operation of displaying the position such as using the visual display or audio display is shown in FIG. 9 by step 811.

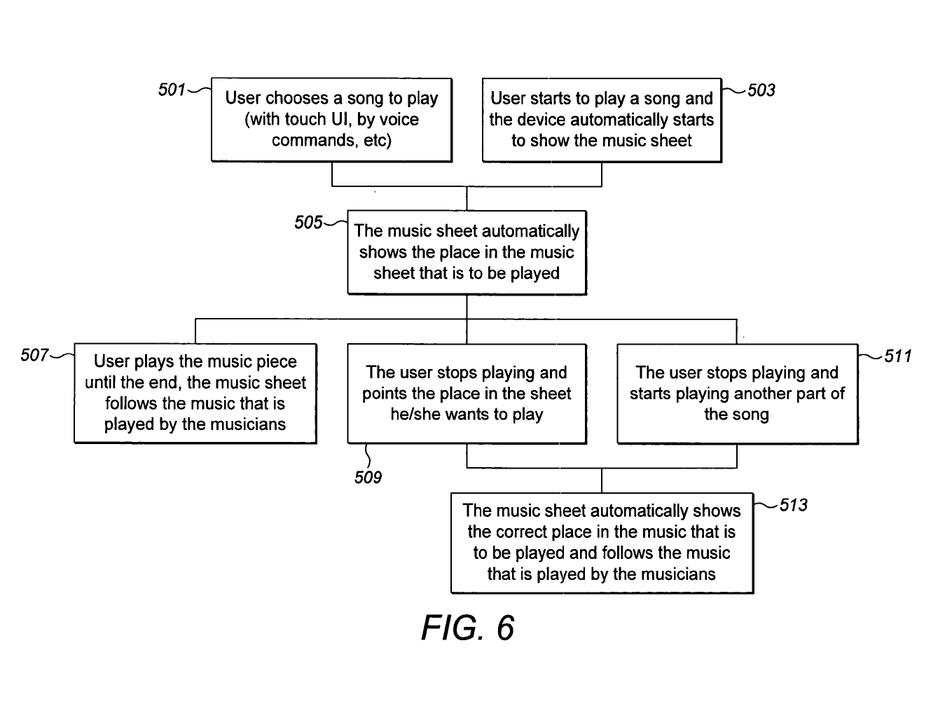

With respect to FIG. 6, the effect of various user interface inputs on the signal comparator/recogniser 103 can be shown. For example in some embodiments the user can be configured to choose a song to play by the user interface such as the touch user interface or by using voice commands. The user selection of the song to play can be seen in FIG. 6 by operation 501.

Alternatively in some embodiments the user can start to play a song or perform a speech and the apparatus as described herein is configured to automatically analyse the audio input to determine the song/track/speech and so to enable the output of the determined sheet music/speech text/lyrics to the display.

The operation of the apparatus automatically determining the song/track/speech is shown in FIG. 6 by operation 503.

Furthermore as shown in FIG. 6, operation 505, once the song/track/speech has been determined or manually selected the apparatus can receive an input to configure the apparatus to automatically display the position or location of the audio signal on a ‘music sheet’.

In some embodiments, the operation can be stopped as the audio signal, for example the instrument played reaches the end of the piece or song. The end of the piece is determined and the display is configured to indicate the end of the piece as shown in FIG. 6 by step 507.

In some embodiments the user could interact with the display, for example to stop the playing by physically stopping the playing and touching the screen (or by simply pausing playing where the apparatus determines the input) for example by the analyser determining a lack of an audio input or the physical input on the touch screen. In such embodiments the display can be configured to show that the audio signal position has paused or halted. This operation of halted or pausing the display of the track is shown in FIG. 6 by step 509.

Furthermore in some embodiments it would be understood that the operator or user could stop playing and start playing another part of the track or song causing the analyser to move to the newly determined position. The operation of determining a ‘stopping’ action and the user ‘starting’ by playing another part of the track/song/speech is shown in FIG. 6 by step 511.

The continuing motion or tracking of the audio signal input operation is also shown in step 513 of FIG. 6.

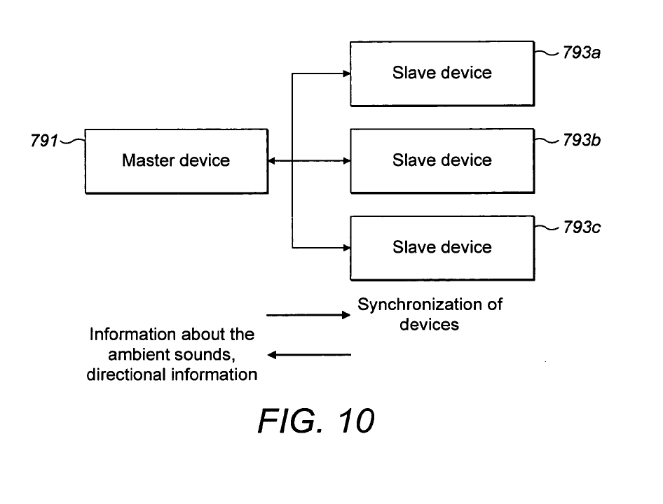

With respect to FIG. 10, the operation of a network arrangement configuration of such apparatus is shown. In such a network of apparatus there can be configured in some embodiments one such apparatus configured as a master device or apparatus 791, and at least one further apparatus configured as a slave device 793. In the example shown in FIG. 10 there are three slave devices 793a, 793b, and 793c. In such examples the master device 791 can be configured to determine a master position of the audio track to be played. For example it is known that in orchestral circles, the strings section follow from the principal of the first section. Thus in some embodiments the master device 791 apparatus can be used to monitor the principal of the first section, and the slave devices monitoring the remainder of the first section and any second and further sections of the strings section of the orchestra.

The master device 791 apparatus having determined the position of the audio signal being monitored can in some embodiments output synchronisation information to the slave devices 793 apparatus informing the slave devices where the master device instrument is currently with regards to the song or sheet music being played.

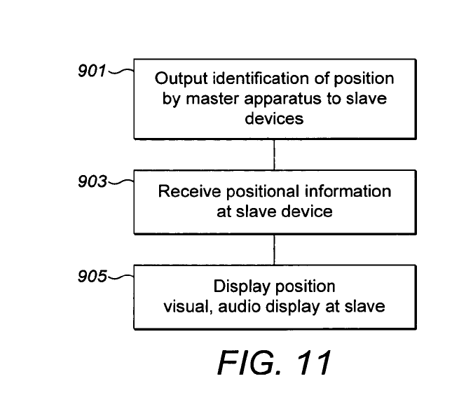

For example the operation of outputting identification of the position of the master device 791 apparatus to slave device 793 apparatus as shown in FIG. 11 by step 901.

The operation of the receiving at the slave device apparatus the positional information of the master device apparatus audio signal is shown in FIG. 11 by step 903.

The slave device 793 apparatus can then be configured to display the position of the master device 791 apparatus location on a suitable display format.

In some embodiments this synchronisation can be done over any suitable interface, wireless or wired. For example the apparatus can be configured with suitable wireless transceivers configured to transceiver using any suitable method such as a Bluetooth communications link, a wireless local area network or any other interface.

It would be understood that the slave devices 793 could as well as displaying the position of the master device 791 apparatus be configured to monitor their received audio signals, perform analysis and matching operations and further determine where their audio signals are in relation to the master device instrument and/or music being performed and thus show whether or not the audio signals being monitored by the slave device 793 apparatus is ahead of, in time with, or behind the master device 791 apparatus monitored audio signal. Furthermore the slave devices 793 apparatus can be configured to display such information in such a way to assist the user of the slave device 793 apparatus so to maintain synchronisation as are as possible.

The operation performed by the slave device apparatus of displaying the position of the master device apparatus audio signal (and in some embodiments the slave device apparatus audio signal) using the visual or audio displays on the slave devices as shown in FIG. 11 by step 905.

For example the master device 791 apparatus could be considered to be the tempo conductor of the band or orchestra group. Furthermore in some embodiments the slave devices 793 apparatus can be configured to pass information about the ambient sounds or directional information to the master device such that the master device can filter the slave device instrument signals from the master device audio input to more accurately determine the position of the master device instrument in relation to the track or music piece being performed.

The determination of which device or apparatus is master and which is slave can be determined manually, for example by use of a user selection on the user interface, or automatically by the apparatus monitoring the audio signal to determine which user generates the ‘best’ or most stable audio signal, or semi-automatically for example by the apparatus determining which of the apparatus is monitoring the most ‘important’ audio signal.

In some embodiments the apparatus master device can be used for example by a band leader/conductor to assist the conduction of the piece. For example in some embodiments the conductor could choose using a suitable user interface input as described herein, for example from a touch display, to monitor individual players in the band/orchestra and display the playing of the selected individuals being monitored by the slave device microphone(s) associated with the selected players. In such embodiments the leader/conductor can pay more attention to specific individual players and help them improve their performances. The master device for example could be configured to display the music that the selected player is playing where the slave device is configured to convert the acoustic music signal played by that player into music sheet, pass it to the master device which then can be configured to display any mistakes the selected individual makes. In some embodiments these mistakes can furthermore be fed back to the individual slave devices and displayed on the slave devices. Furthermore in some embodiments the master device can further generate comments which can be displayed on the slave devices can be associated with the mistakes to assist the individual to not make the same mistake.

It would be understood that in some embodiments the apparatus can further be configured as a ad-hoc network of apparatus and/or configured to display any number of other apparatus positions (and in some embodiments their own captured audio signal as well).

Furthermore in some embodiments the apparatus can be configured to operate both within the same audio space (for example an orchestra or band practicing in the same room), but also in some embodiments over more than one audio space, for example to permit groups of people to practice music pieces despite not being in the same room.

Thus user equipment may comprise an audio tracker such as those described in embodiments of the application above.

It shall be appreciated that the term user equipment is intended to cover any suitable type of wireless user equipment, such as mobile telephones, portable data processing devices or portable web browsers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

Therefore in summary at least one embodiment of the invention comprises an apparatus configured to: receive a first audio signal; determine at least one characteristic associated with the first audio signal; compare the at least one characteristic against at least one characteristic associated with at least one further audio signal; and display the at least one characteristic associated with at least one further audio signal dependent on the first audio signal characteristic.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-55. (canceled)

56. A method comprising:
displaying, at least partially, at least one audio signal;
receiving a further audio signal;
determining at least one characteristic from the received further audio signal;
comparing the at least one characteristic against an at least one audio signal characteristic so as to track a position within the at least one audio signal; and
indicating the tracked position of the at least one audio signal.

57. The method as claimed in claim 56, wherein receiving a further audio signal comprises providing the further audio signal using at least one microphone.

58. The method as claimed in claim 56, wherein determining at least one characteristic associated with the further audio signal comprises at least one of:
determining the further audio signal music title;
determining the further audio signal speech title;
determining the further audio signal music location;
determining the further audio signal speech location;
determining the further audio signal tempo;
determining the further audio signal note;
determining the further audio signal chord;
determining the further audio signal frequency response;
determining one or more frequency and/or amplitude component of the further audio signal;
determining the further audio signal bandwidth;
determining the further audio signal noise level and/or signal to noise level ratio;
determining the further audio signal phase response;
determining the further audio signal loudness;
determining the further audio signal impulse response;
determining one or more onsets of the further audio signal;
determining the further audio signal waveform;
determining the further audio signal timbre;
determining the further audio signal beat;
determining the further audio signal envelope function;
determining the further audio signal power;
determining the further audio signal power spectral density; and
determining the further audio signal pitch.

59. The method as claimed in claim 56, wherein indicating the tracked position of the at least one audio signal further comprises visually displaying the at least one audio signal characteristic dependent on the determined characteristic of the at least one further audio signal.

60. The method as claimed in claim 56, wherein determining at least one characteristic from the received further audio signal comprises at least one of: determining at least one searchable parameter associated with the further audio signal; and
searching the at least one searchable parameter within the at least one audio signal to determine at least one location within the at least one audio signal.

61. The method as claimed in claim 56, wherein comparing the determined at least one characteristic against the at least one audio signal characteristic further comprises determining at least one difference value associated with the tracked position and an expected position.

62. The method as claimed in claim 61, wherein indicating the tracked position of the at least one audio signal further comprises displaying the at least one difference value.

63. The method as claimed in claim 56, wherein indicating the tracked position of the at least one audio signal further comprises displaying the tracked position associated with the determined characteristic of the further audio signal on a visual representation of the at least one audio signal.

64. An apparatus comprising at least one processor and at least one memory including computer program code for one or more programs, the at least one memory and the computer program code configured to, with the at least one processor, causes the apparatus to:
display, at least partially, at least one audio signal;
receive a further audio signal;
determine at least one characteristic from the received further audio signal;
compare the determined at least one characteristic against an at least one audio signal characteristic so as to track a position within the at least one audio signal; and
indicate the tracked position of the at least one audio signal dependent on the determined further audio signal characteristic.

65. The apparatus as claimed in claim 64, wherein the received further audio signal is provided by at least one microphone.

66. The apparatus as claimed in claim 64, wherein the determined at least one characteristic further causes the apparatus to at least one of:
determine the further audio signal music title;
determine the further audio signal speech title;
determine the further audio signal music location;
determine the further audio signal speech location;
determine the further audio signal tempo;
determine the further audio signal note;
determine the further audio signal chord;
determine the further audio signal frequency response;
determine one or more frequency and/or amplitude component of the further audio signal;
determine the further audio signal bandwidth;
determine the further audio signal noise level and/or signal to noise level ratio;
determine the further audio signal phase response;
determine the further audio signal loudness;
determine the further audio signal impulse response;
determine one or more onsets of the further audio signal;
determine the further audio signal waveform;
determine the further audio signal timbre;
determine the further audio signal beat;
determine the further audio signal envelope function;
determine the further audio signal power;
determine the further audio signal power spectral density; and
determine the further audio signal pitch.

67. The apparatus as claimed in claim 64, wherein the indicated tracked position of the at least one audio signal causes the apparatus to visually display the at least one audio signal characteristic dependent on the determined characteristic of the at least one further audio signal.

68. The apparatus as claimed in claim 64, wherein the determined at least one characteristic from the received further audio signal causes the apparatus to at least one of:
determine at least one searchable parameter associated with the further audio signal; and
searching the at least one searchable parameter within the at least one audio signal to determine at least one location within the at least one audio signal.

69. The apparatus as claimed in claim 64, wherein the comparison is further causes the apparatus to determine at least one difference value associated with the tracked position and an expected position.

70. The apparatus as claimed in claim 69, wherein the indicated tracked position of the at least one audio signal further causes the apparatus to display the determined at least one difference value.

71. The apparatus as claimed in claim 70, wherein the indicated tracked position is displayed on a visual representation of the at least one audio signal.

72. The apparatus as claimed in claim 68, wherein the apparatus is further caused to match the determined at least one searchable parameter against at least one searchable parameter within the at least one audio signal.

73. The apparatus as claimed in claim 64, wherein the apparatus further comprising a receiver configured to receive the further audio signal.

74. The apparatus as claimed in claim 64, wherein the apparatus further comprising a comparator configured to compare the determined at least one characteristic against the at least one audio signal characteristic.

75. The apparatus as claimed in claim 64, wherein the apparatus further comprising a display configured to display at least one of:
the at least one audio signal characteristic dependent on the determined characteristic;
a visual representation of the at least one audio signal characteristic; and
a visual representation of the tracked position within the at least one audio signal.
